(19) United States
(12) Patent Application Publication
(10) Pub. No.: US 2005/0279800 A1
(43) Pub. Date: Dec. 22, 2005

(54) Simple ahdesive tape cutter

(76) Inventor: Yu-Gang Chen, Junghe (TW)

Correspondence Address: Yu-Gang Chen, P.O. Box No. 6-57, Junghe, Taipei, 235, TW

(21) Appl. No.: 10/870,989

(22) Filed: Jun. 21, 2004

(51) Int. Cl. B26F 3/02

(52) U.S. Cl. 225/61; 225/91

(57) ABSTRACT

A simple adhesive tape cutter according to the invention includes a cutter seat, which has elastic and flexible fastening section and fastening member at lower side portions thereof and sawteeth at an edge of an upper surface thereof, thereby being quickly accommodated around an adhesive tape roll and readily cutting of adhesive tape.

### BACKGROUND OF THE INVENTION

(a) Field of the Invention

The invention relates to a simple adhesive tape cutter, and more particularly, to an adhesive tape cutter having an elastic and flexible fastening section for accommodating around an adhesive tape roll, thereby readily cutting off the adhesive tape while leaving an appropriate length at a cut-off end for facilitating a next usage.

(b) Description of the Prior Art

A current adhesive tape roll is frequently installed on a cutter for quickly cutting the adhesive tape. However, the cutter has a large volume that occupies a large space, and is thus awkward with respect to portability thereof. Therefore, the inventor provided a structure disclosed by the Taiwan Patent Publication 563882, Light and Portable Adhesive Tape Cutter, as shown in FIG. 15. The prior invention comprises a gathering section A as a flexible strip body having a fixed cutter seat A1, which is provided with an inserted screw A2, and sawteeth A3 at a side edge thereof. The gathering section A is devised with a sliding cutter seat A4 at the other end thereof. The sliding cutter seat A4 is provided with a sliding groove A5. The sliding cutter seat A4 has sawteeth at a same side as the sawteeth A3 of the fixed cutter seat A1 for corresponding with the sawteeth A3. The sliding cutter seat A4 is overlapped with the fixed cutter seat A1 and is capable of relative movements. The aforesaid structure is fastened using a screw A2 and is adaptable for adhesive tapes having different widths. However, according to the prior invention, the gathering section A is respectively provided with the fixed cutter seat A1 and the sliding cutter seat A4, which together with the screw A2 and the sliding groove A5 all need additional manufacturing time and effort. Thus, not only manufacturing time is much wasted, but also production costs are significantly increased. As a result, the prior invention may have rather limited sales quantity and may fail to be extensive utilized. Furthermore, it is necessary that the screw A2 be first loosened to adapt to adhesive tapes having different widths, followed by moving the sliding cutter seat A4 and then tightening the screw A2. The overall application is rather complex and provides inadequate practicability.

### SUMMARY OF THE INVENTION

The object of the invention is to provide a simple adhesive tape cutter having a simple structure, low production costs, and a small volume occupying minimal space for offering handy portability, thereby quickly cutting off an adhesive tape of an appropriate length as well as leaving a cut-off end with an appropriate length for facilitating cutting off the adhesive tape in a next usage.

A simple adhesive tape cutter according to the invention comprises a cutter seat, which has an elastic and flexible fastening section and sawteeth at an edge of an upper surface thereof.

### BRIEF DESCRIPTION OF THE DRAWINGS

FIG. 1 shows an elevational schematic view illustrating a first embodiment according to the invention.

FIG. 2 shows a schematic view illustrating a first embodiment according to the invention in use.

FIG. 3 shows a schematic view illustrating a first embodiment according to the invention cutting off an adhesive tape.

FIG. 4 shows an elevational schematic view illustrating a second embodiment according to the invention.

FIG. 5 shows an elevational schematic view illustrating a third embodiment according to the invention.

FIG. 6 shows an elevational schematic view illustrating a fourth embodiment according to the invention.

FIG. 7 shows a schematic view illustrating a cutter seat being pushed in a fourth embodiment according to the invention.

FIG. 8 shows a schematic view illustrating adhesive tape being cut off in a fourth embodiment according to the invention.

FIG. 9 shows an exploded schematic view of a fifth embodiment according to the invention.

FIG. 10 shows a schematic view illustrating a cutter seat being pushed in a fifth embodiment according to the invention.

FIG. 11 shows a schematic view illustrating adhesive tape being cut off in a fifth embodiment according to the invention.

FIG. 12 shows a schematic view illustrating a cutter seat being pushed in a sixth embodiment according to the invention.

FIG. 13 shows a schematic view illustrating adhesive tape being cut off in a sixth embodiment according to the invention.

FIG. 14 shows an exploded elevational view of a seventh embodiment according to the invention.

FIG. 15 shows a schematic view of a prior adhesive tape cutter.

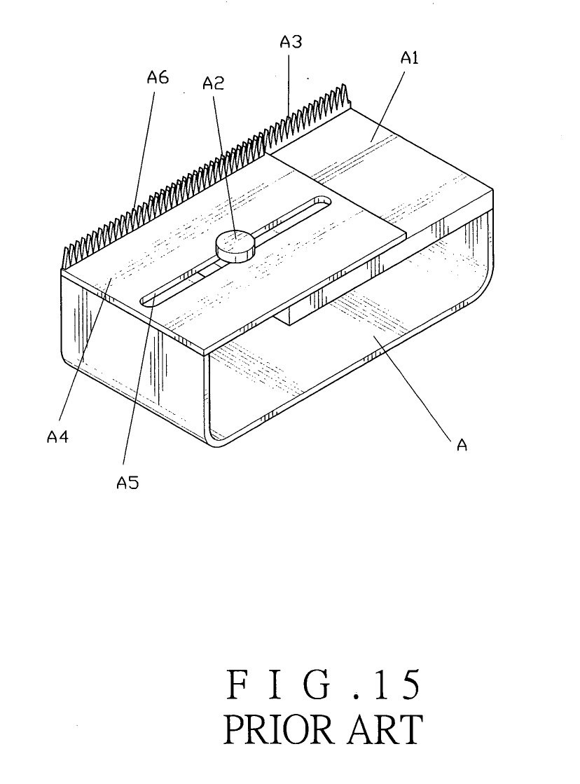

### DETAILED DESCRIPTION OF THE PREFERRED EMBODIMENTS

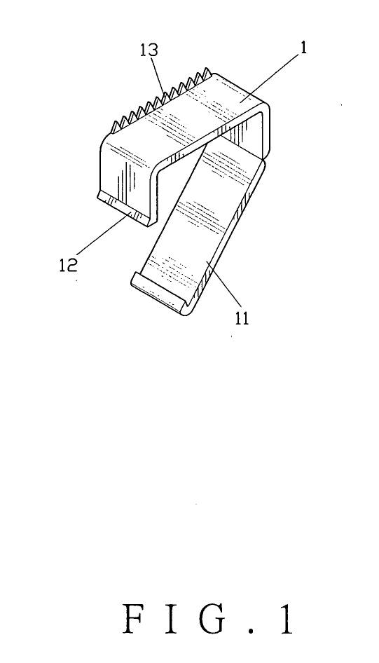

Referring to FIG. 1 showing a first embodiment according to the invention, the invention comprises a cutter seat 1, which has an elastic and flexible fastening section 11 at a lower side portion thereof in a bent manner, with the fastening section 11 as a formed integral with the cutter seat 1 or pivotally connected to the cutter seat 1; a fastening member 12 at an edge of the other side thereof; and a row of sawteeth 13 at one edge of an upper surface thereof.

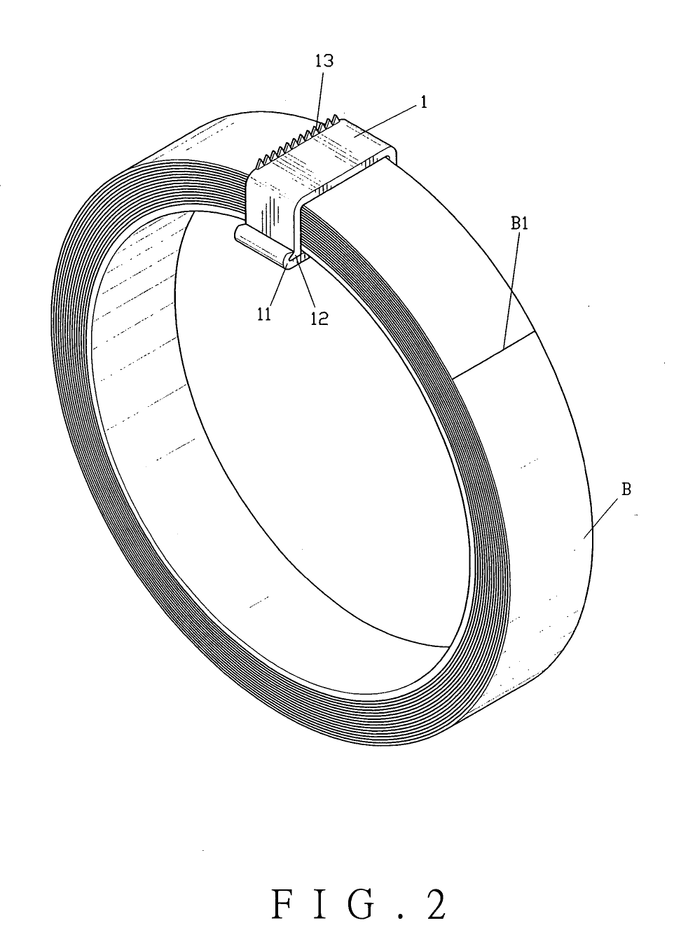

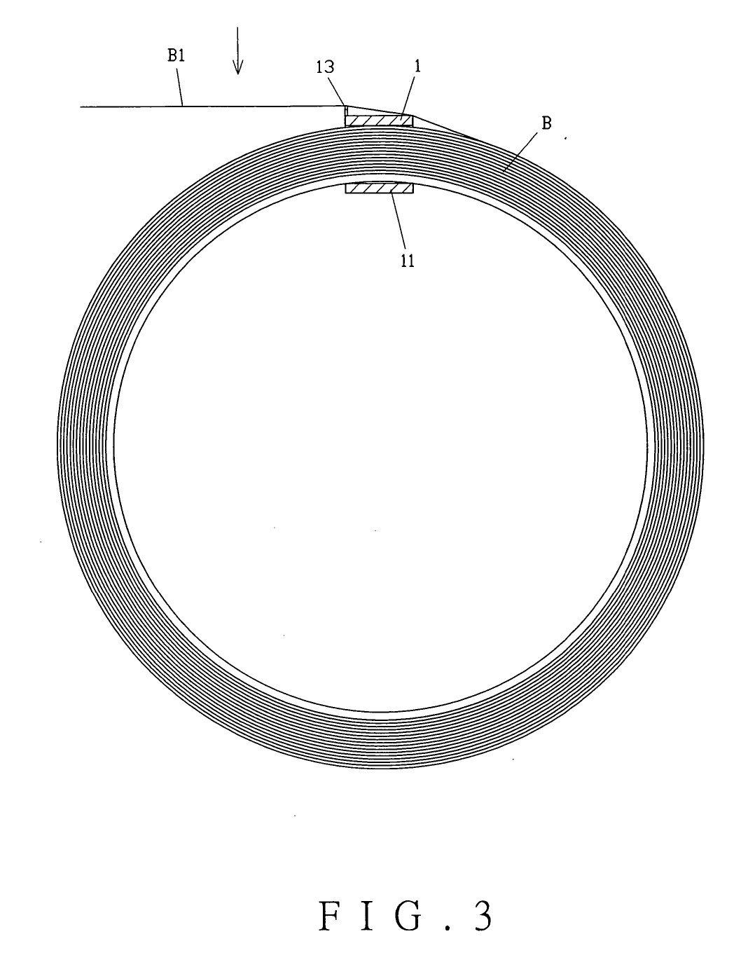

To put the aforesaid structure to use, referring to FIG. 2, the fastening section 11 at one side of the cutter seat 1 is bound around an adhesive tape roll B, and the fastening section 11 is fastened with the fastening member 12, such that the cutter seat 1 stays mobile around the adhesive tape B. To cut the adhesive tape, the cutter seat 1 is moved at the adhesive tape roll B, and an edge with the sawteeth 13 of the cutter seat 1 is butted against a cut-off end B1 of the adhesive tape roll B. An appropriate length of adhesive tape to be cut off is picked, and the cut-off end B1 of the adhesive tape is pressed downward as shown in FIG. 3, thereby quickly and readily cutting off the adhesive tape using the sawteeth 13.

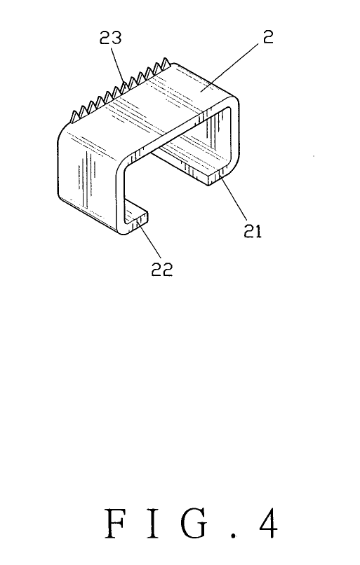

Referring to FIG. 4 showing a second embodiment according to the invention, the invention comprises a cutter seat 2, which has two elastic and flexible fastening sections 21 and 22 at two lower sides thereof, and a row of sawteeth 23 at one edge of an upper surface thereof. To put the structure to use, referring to FIG. 3, the two fastening sections 21 and 22 of the cutter seat 2 are bound around two sides of the adhesive tape roll B. Using elasticity and flexibility of the cutter seat 1, the fastening sections 21 and 22 are fastened around the adhesive tape B in a mobile manner. To cut off the adhesive tape, the cutter seat 1 is moved at the adhesive tape roll B, and an edge with the sawteeth 13 of the cutter seat 1 is butted against the cut-off end B1 of the adhesive tape roll B. An appropriate length of adhesive tape to be cut off is picked, and the cut-off end B1 of the adhesive tape is pressed downward as shown in FIG. 3, thereby quickly and readily cutting off the adhesive tape using the sawteeth 13.

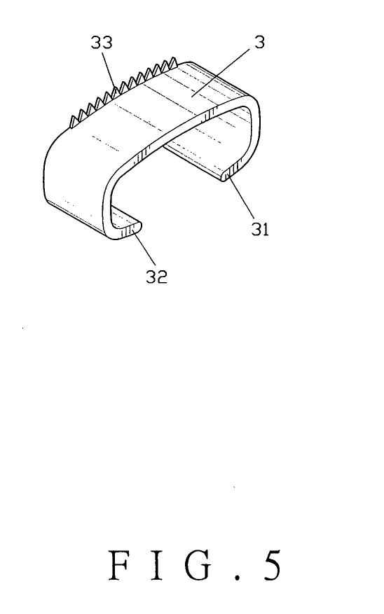

Referring to FIG. 5 showing a third embodiment according to the invention, the invention comprises a cutter seat 3, which has two elastic and flexible fastening sections 31 and 32 at two lower side portions thereof, and a row of sawteeth 33 at one edge of an upper surface thereof. The cutter seat 3 is especially devised as having an arched sectional area for adapting to adhesive tapes having different shapes. The embodiment according to the invention has a unique design and provides esthetical values for increasing selling points and promoting sales quantity, while also accomplishes quickly and readily cutting off an adhesive tape.

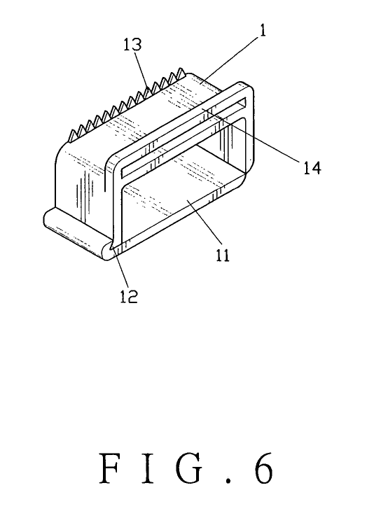

Referring to FIG. 6 showing a fourth embodiment according to the invention, the invention comprises a cutter seat 1, which has an elastic and flexible fastening section 11 at a lower side portion thereof in a bent manner; a fastening member 12 at the other lower side portion thereof; a row of sawteeth 13 at one edge of an upper surface thereof; and a U-shaped arm 14 at the other edge of the upper surface thereof.

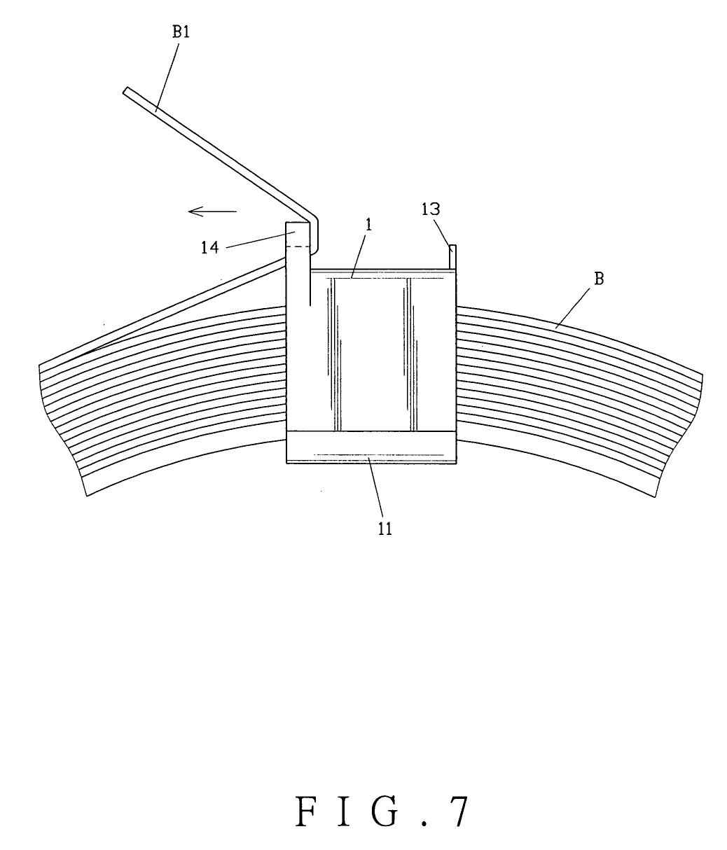

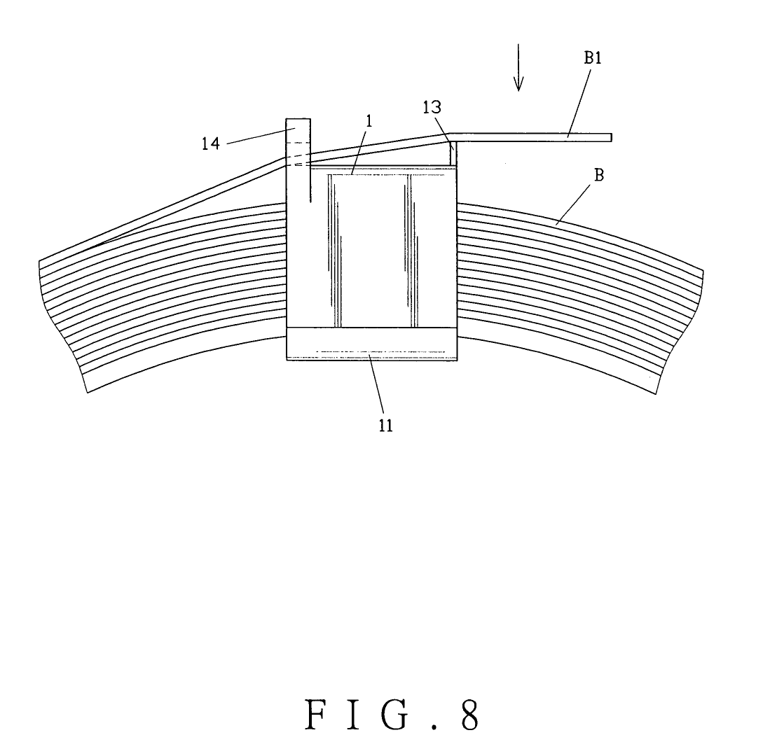

To put the aforesaid structure to use, referring to FIG. 7, the fastening section 11 at one side of the cutter seat 1 is bound round the adhesive tape roll B, and the fastening section 11 is fastened with the fastening member 12, such that the cutter seat 1 stays mobile around the adhesive tape B, and the cut-off end B1 of the adhesive tape roll B is inserted through the arm 14. To cut the adhesive tape, the cutter seat 1 is moved at the adhesive tape roll B, and an edge with the sawteeth 13 of the cutter seat 1 is butted against a cut-off end B1 of the adhesive tape roll B. To cut off the adhesive tape, the cut-off end B1 of the adhesive tape roll B is first pulled toward the arm 14 to move the cutter seat 1 to an appropriate length to be cut off, butted against the sawteeth 13 at the cutter seat 1 as shown in FIG. 8, and pressed downward to have the adhesive tape cut off by the sawteeth 13. Thus, an appropriate length of the adhesive tape quickly is cut off, and an appropriate length is left at the cut-off end B1 for facilitating a next usage.

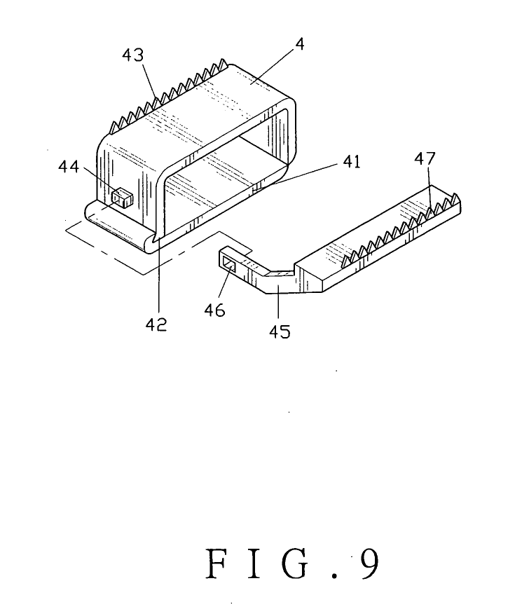

Referring to FIG. 9 showing a fifth embodiment according to the invention, the invention comprises a cutter seat 4, which has an elastic and flexible fastening section 41 at a lower side portion thereof in a bent manner; a fastening member 42 at the other lower side portion thereof; a row of sawteeth 43 at one edge of an upper surface thereof; an embedding member 44 at one side wall thereof; an arm 45 embedded at the embedding member 44 and appears as a slanted L-shape; an embedding opening 46 at an end portion of the arm 45 and for wedging with the embedding member 44; and a row of sawtooth 47 at one edge of an upper surface of the arm 45.

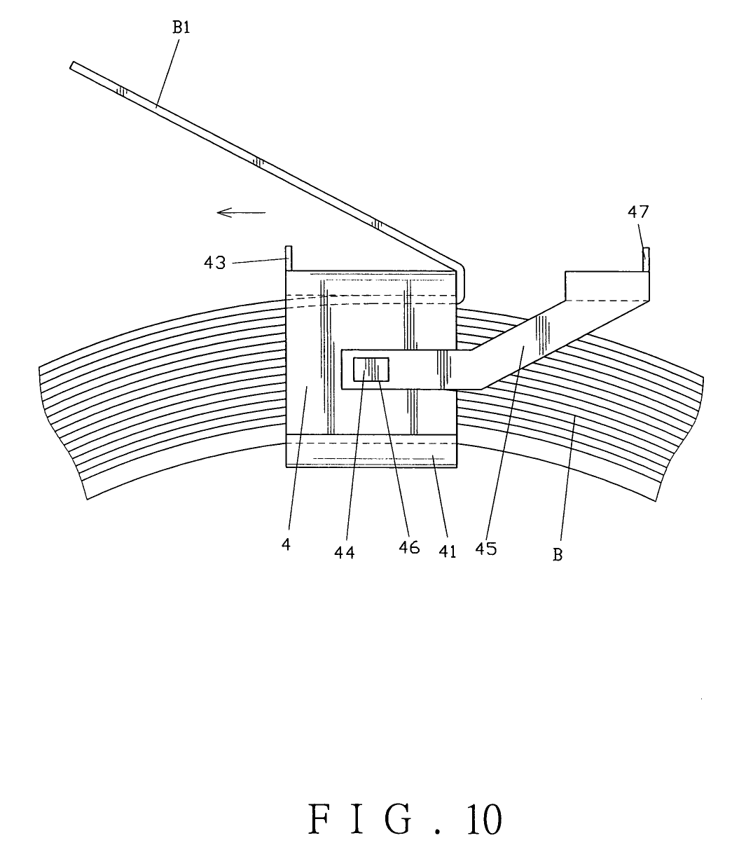

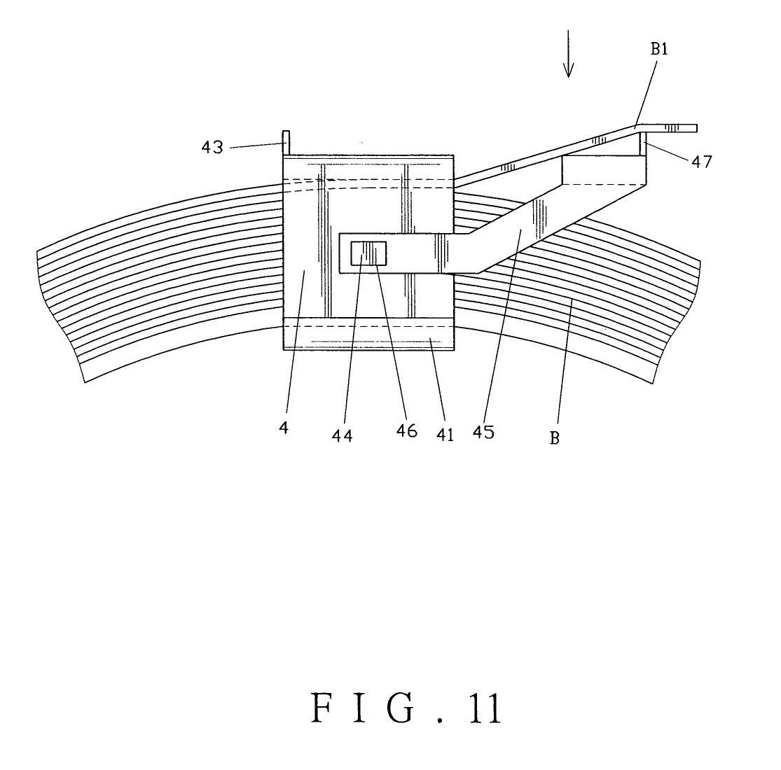

To put the aforesaid structure to use, referring to FIG. 10, the fastening 41 of the cutter seat 4 is bound around the adhesive tape roll B, and the fastening section 41 is fastened with the fastening section 42, such that the fastening seat 4 is accommodated around the adhesive tape roll B in a mobile manner. The cut-off end B1 of the adhesive B is passed through an inner side of the cutter seat 4 and inserted through between an end portion and the arm 45. To cut off the adhesive tape, the cut-off end B1 of the adhesive tape roll B is first pulled toward the cutter seat 4 to move the cutter seat 4 to reach an appropriate length to be cut off, butted against the sawteeth 47 at the arm 45 as shown in FIG. 11, and pressed downward to have the adhesive tape cut off by the sawteeth 47, with an appropriate length of the adhesive tape left at the arm 45. Thus, an appropriate length of the adhesive tape quickly is cut off, and an appropriate length is left at the cut-off end B1 for facilitating a next usage.

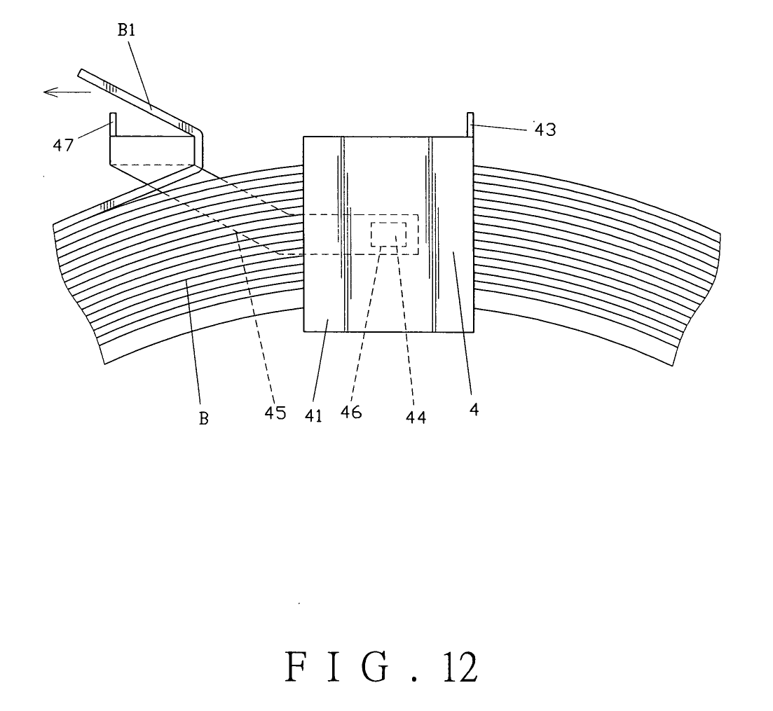

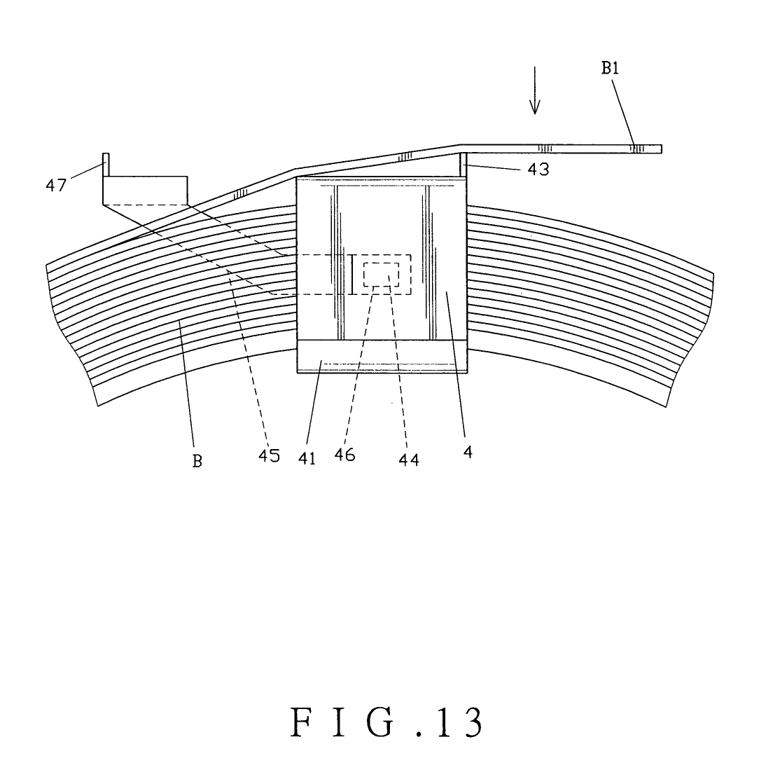

Referring to FIG. 12 showing a sixth embodiment according to the invention, the fastening section 41 at one side of the cutter seat 4 is reversely bound around the adhesive tape roll B, and is then fastened with the fastening member 42, such that the cutter seat 4 is reversely accommodated around the adhesive tape roll B in a mobile manner. Also, the cut-off end B1 of the adhesive tape roll B is inserted through between the end portion of the cutter 4 and the arm 45. To cut off the adhesive tape, the cut-off end B1 of the adhesive tape roll B is first pulled toward the arm 45 to push the arm 45 to reach an appropriate length to be cut off, reversely butted against the sawteeth 43 of the cutter seat 4 as shown in FIG. 13, and pressed downward to have the adhesive tape cut off by the sawteeth 43. Thus, an appropriate length of the adhesive tape quickly is cut off, and an appropriate length is left at the cut-off end B1 for facilitating a next usage.

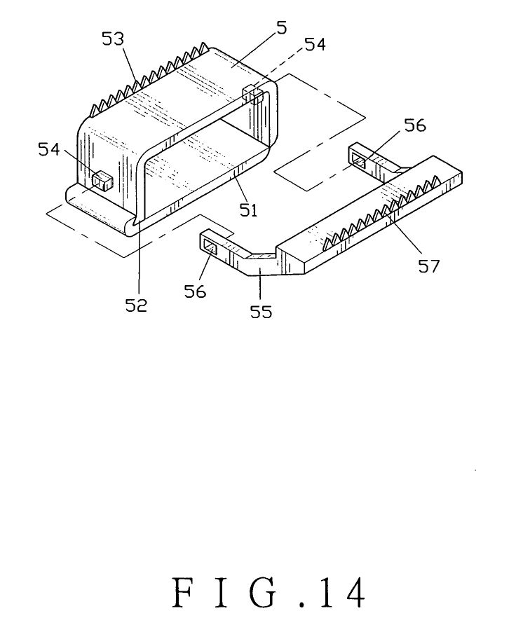

Referring to FIG. 14 showing a seventh embodiment according to the invention, the invention comprises a cutter seat 5, which has an elastic and flexible fastening section 51 at a lower side portion thereof in a bent manner, a fastening member 52 at the other lower side portion thereof, a row of sawteeth 53 at one edge of an upper surface thereof, an embedding member 54 at each of two side walls thereof, an arm 55 at each of the embedding members 54, an embedding opening 56 at each of the arms 55, and a row of sawteeth at an upper surface of the arm 55. Wherein, the arms 55 are devised as slanted L-shaped, and have two end portions thereof provided with the embedding openings 56 wedged with the two embedding members 54. Operating methods of this embodiment are the same as those of aforementioned embodiments, and therefore shall not be further illustrated. Thus, an appropriate length of the adhesive tape quickly is cut off, and an appropriate length is left at the cut-off end for facilitating a next usage.

Conclusive from the aforesaid descriptions, the invention has the following excellences:
1. The cutter seat according to the invention has elastic and flexible fastening section and fastening member at sides thereof, and thus can be quickly bound around an adhesive tape roll for readily cutting of the adhesive tape.
2. The cutter seat according to the invention has a simple structure, low production costs, a small volume occupying minimal space, and easy portability.
3. The cutter seat according to the invention can be devised in different shapes for adapting to adhesive tapes in various styles.
4. The cutter seat according to the invention is connected or embedded with arms, which promote quickly cutting off an appropriate length of the adhesive tape while also leaving a cut-off end for facilitating a next usage.

It is of course to be understood that the embodiments described herein are merely illustrative of the principles of the invention and that a wide variety of modifications thereto may be effected by persons skilled in the art without departing from the spirit and scope of the invention as set forth in the following claims.

1. A simple adhesive tape cutter comprising a cutter seat, which has an elastic and flexible fastening section and sawteeth at an edge of an upper surface thereof.

2. The simple adhesive tape cutter in accordance with claim 1, wherein the fastening section is provided at a lower side portion of the cutter seat in a bent manner, and the cutter seat has a fastening member at the other lower side portion for fastening and locating with the fastening section.

3. The simple adhesive tape cutter in accordance with claim 1, wherein the fastening section is provided at each of two lower side portions of the cutter seat.

4. The simple adhesive tape cutter in accordance with claim 1, wherein the cutter seat has an end portion thereof provided with a joined arm.

5. The simple adhesive tape cutter in accordance with claim 1, wherein the cutter seat has a side wall thereof provided with an embedding member for embedding an arm having sawteeth at an upper surface thereof.

6. The simple adhesive tape cutter in accordance with claim 5, wherein the embedding member is provided at one side wall of the cutter seat and is devised in a slanted L-shape.

7. The simple adhesive tape cutter in accordance with claim 5, wherein the embedding member is provided at each of two side walls of the cutter seat, and the arm is provided in a slanted U-shape.
